(19) United States
(12) Patent Application Publication
(10) Pub. No.: US 2025/0089087 A1
(43) Pub. Date: Mar. 13, 2025

(54) REGIONAL CLEAR CHANNEL ASSESSMENT (CCA) SIGNALING WITH FALLBACK DOWNLINK CONTROL INDICATION (DCI) AND USER EQUIPMENT (UE) LISTEN BEFORE TALK (LBT) PROCEDURES

(71) Applicant: Apple Inc., Cupertino, CA (US)

(72) Inventors: Huaning Niu, San Jose, CA (US); Chunxuan Ye, San Diego, CA (US); Dawei Zhang, Satatoga, CA (US); Hong He, San Jose, CA (US); Oghenekome Oteri, San Diego, CA (US); Sigen Ye, San Diego, CA (US); Wei Zeng, Saratoga, CA (US); Yushu Zhang, Beijing (CN)

(21) Appl. No.: 18/725,267

(22) PCT Filed: Jan. 10, 2022
(86) PCT No.: PCT/CN2022/071066

§ 371 Date: Jun. 28, 2024

(51) Int. Cl. H04W 74/0808; H04W 74/00; H04W 74/0833

(52) U.S. Cl. CPC H04W 74/0808; H04W 74/006; H04W 74/0833

(57) ABSTRACT

Techniques discussed herein can facilitate listen before talk procedures for clear channel assessment signaling. One example aspect is a baseband processor of a user equipment (UE), including one or more processors configured to receive system information including a region indication for clear channel assessment (CCA) procedures. The CCA procedures are associated with a listen before talk (LBT) region configuration for one of a first region, a second region, or a third region. One or more processors are configured to receive a downlink control information (DCI) in a physical downlink control channel (PDCCH) message that includes a DCI CCA indication. Subsequently, the one or more processors are configured to perform an initial LBT procedure associated with the region indication and generate a random access channel (RACH) message after performing the initial LBT procedure. Finally, the one or more processors generate an uplink (UL) message according to the DCI CCA indication.

### FIELD

The present disclosure relates to wireless technology including New Radio (NR) listen before talk procedures and methods for regional clear channel assessment signaling.

### BACKGROUND

Mobile communication in the next generation wireless communication system, 5G, or new radio (NR) network will provide ubiquitous connectivity and access to information, as well as the ability to share data, around the globe. 5G networks and network slicing will be a unified, service-based framework, that will target to meet versatile, and sometimes conflicting, performance criteria. 5G networks will provide services to vastly heterogeneous application domains ranging from Enhanced Mobile Broadband (eMBB) to massive Machine-Type Communications (mMTC), Ultra-Reliable Low-Latency Communications (URLLC), and other communications. In general, NR will evolve based on third generation partnership project (3GPP) long term evolution (LTE)-Advanced technology with additional enhanced radio access technologies (RATs) to enable seamless and faster wireless connectivity solutions.

### BRIEF DESCRIPTION OF THE DRAWINGS

FIG. 1 is an exemplary block diagram illustrating an example of user equipment(s) (UEs) communicatively coupled to a network in accordance with various aspects described herein.

FIG. 2 is a signal flow diagram outlining example signaling for regional clear channel assessment (CCA) signaling and listen before talk (LBT) procedures.

FIG. 3 is a signal flow diagram outlining example signaling for regional clear channel assessment (CCA) signaling and updated listen before talk (LBT) procedures after a user equipment (UE) establishes a connection with a base station (BS).

FIG. 4 illustrates a flow diagram of an example method for base station (BS) to user equipment (UE) listen before talk (LBT) mode configuration for regions where LBT is not mandated.

FIG. 5 illustrates a flow diagram of an example method for regional clear channel assessment (CCA) signaling and listen before talk (LBT) procedures of a user equipment (UE).

FIG. 6 illustrates a flow diagram of an example method for regional clear channel assessment (CCA) signaling and listen before talk (LBT) procedures of a base station (BS).

FIG. 7 illustrates a flow diagram of an example method for clear channel assessment (CCA) signaling corresponding to updated listen before talk (LBT) procedures by a user equipment (UE).

FIG. 8 illustrates a flow diagram of an example method for clear channel assessment (CCA) signaling corresponding to updated listen before talk (LBT) procedures by a base station (BS).

FIG. 9 illustrates an example of an infrastructure equipment, in accordance with various aspects disclosed.

FIG. 10 illustrates an example of a user equipment (UE) or base station (BS) platform, in accordance with various aspects disclosed.

### DETAILED DESCRIPTION

5G or NR networks may use a clear channel assessment (CCA) procedure before using a channel, for example, to determine if a channel is in use or clear for use. CCA procedures for the 60 GHz band (e.g. 57 GHz to 71 GHZ) can be used in conjunction with License Assisted Access (LAA) technologies for unlicensed bands such that the unlicensed spectrum use can coexist with other Radio Access Technologies (RATs). In some aspects, CCA procedures can make use of listen before talk (LBT) configurations to determine if a channel is available for use.

The CCA procedure can be region specific, for example, in the United States (US) the Federal Communications Commission (FCC) may regulate CCA procedures and may not mandate a LBT procedure before using a channel, thus making LBT procedures optional. A region where LBT operations are optional and not mandated can be referred to as a first region. In another example, the CCA procedure is regulated by European standards and can specifically be regulated by European Telecommunications Standards Institute (ETSI) EN 302 567, which can predominantly include Category 3 (CAT3) LBT procedures. A region where LBT operations are regulated by European standards can be referred to as a second region. In another example, the CCA procedure is regulated by Japanese standards where LBT is mandatory to facilitate spectrum sharing. A region where LBT operations are mandatory can be referred to as a third region. CCA and LBT procedures for the 60 GHz band require signaling between the user equipment (UE) and network (NW) for effective channel access and use in different regions.

Various aspects of the present disclosure are directed towards CCA signaling between the UE and the NW and can apply to the 60 GHz band or other bands. Mechanisms by which the NW can indicate a region configuration are presented. Furthermore, mechanisms by which the UE can perform initial access with the NW according to the region are presented herein. Mechanisms to indicate LBT procedures via downlink control information (DCI) are discussed herein. Mechanisms by which the UE can update the LBT behavior after initial access are also discussed herein. Mechanisms presented herein facilitate CCA procedures between the UE and the NW by addressing various signaling, channel access, and LBT aspects in an efficient manner.

In some aspects, the NW can configure a channel access mode indication (e.g., channelAccessMode-r17) that indicates the first, second, or third region. As such, the channel access mode can include a region indication. In some instances, the NW can transmit a physical downlink shared channel (PDSCH) message with a system information block 1 (SIB1) comprising the channel access mode. The UE can receive the SIB1 comprising the channel access mode and perform initial access with the NW according to a LBT procedure associated with the received region indication contained in the channel access mode. For example, the UE can perform a random access channel (RACH) procedure including a message 1 (Msg1) or message A (MsgA) transmission according to the LBT procedure specified by the region indication.

The LBT procedure can follow one or more of several categories including a category 1 (CAT1), category 2 (CAT2), category 3 (CAT3), associated with the indicated first, second, or third region. As such, the UE can perform one or more of the CAT1, CAT2, or CAT3 procedure before transmitting the RACH Msg1 or MsgA.

In addition to receiving the region indication, the UE can receive a DCI in a physical downlink control channel (PDCCH) message comprising a DCI CCA indication for LBT procedures before transmitting UL messages, and LBT procedure update or upgrade information for subsequent messaging that is different than the LBT procedure associated with initial access. The DCI CCA indication can be associated with the DCI itself without CCA specific bits. In other aspects, the DCI CCA indication is associated with CCA specific bits in a DCI format (e.g. format 0_0, 0_1, 0_2, 1_0, 1_1, 1_2 etc.).

In regions where LBT is not mandated, such as in region 1, for example, the NW can indicate a LBT mode for a communication link between the Base Station (BS) and the UE. In such aspects, the UE can determine under what conditions the UE should perform validation of BS transmitted messages depending on BS or UE specific LBT mode configuration as is pre-configured or indicated by the NW.

Thus, CCA described herein facilitates spectrum sharing between licensed and unlicensed spectrums by employing various aspects of LBT.

Additional aspects and details of the disclosure are further described below with reference to figures.

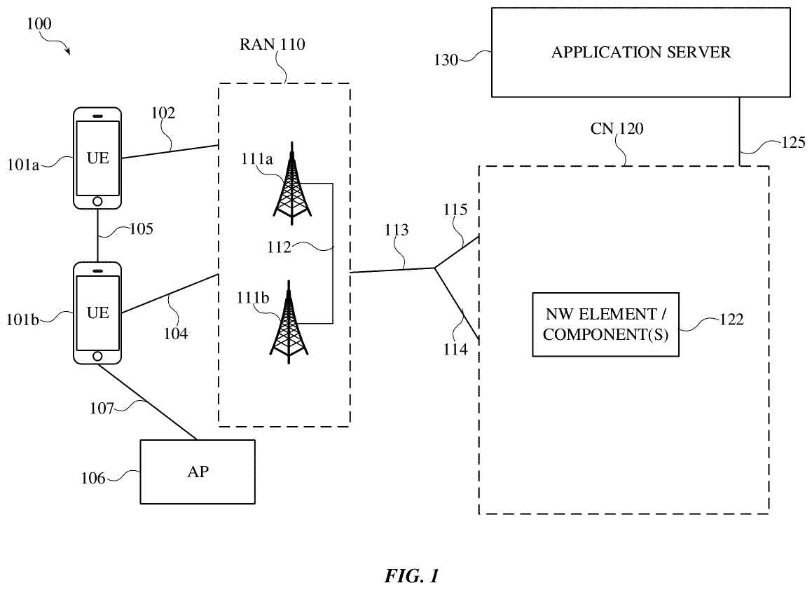

FIG. 1 illustrates example architecture of a wireless communication system 100 of a network that includes UE 101a and UE 101b (collectively referred to as “UEs 101” or “UE 101”), a radio access network (RAN) 110, and a core network (CN) 120. The UEs communicate with the CN 120 by way of the RAN 110. In aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system 100, and the term “E-UTRAN” or the like can refer to a RAN 110 that operates in an LTE or 4G system 100. The UEs 101 utilize connections (or channels) 102 and 104, respectively, each of which comprises a physical communication interface/layer. Channels 102 and 104 can facilitate one or more of licensed or unlicensed communication bands between the UE 101 and the RAN 110.

Accordingly, the UE 101 can receive the channel access mode indication which can be the region indication in the SIB1 comprised in the PDSCH message by connections 102 or 104. Furthermore, the UE 101 can receive the DCI CCA indication in a PDCCH message by connections 102 or 104. The UE 101 can perform an initial LBT procedure according to the region indication before transmitting an initial access RACH message (e.g. RACH Msg1) over connections 102 or 104. The UE 101 can perform a LBT procedure according to the DCI CCA indication and transmit the UL message by connections 102 or 104.

Alternatively, or additionally, each of the UEs 101 can be configured with dual connectivity (DC) as a multi-RAT or multi-Radio Dual Connectivity (MR-DC), where a multiple Rx/Tx capable UE may be configured to utilize resources provided by two different nodes (e.g., 111a, 111b, 112, or other network nodes) that can be connected via non-ideal backhaul, one providing NR access and the other one providing either E-UTRA for LTE or NR access for 5G, for example.

Alternatively, or additionally, each of the UEs 101 can be configured in a CA mode where multiple frequency bands are aggregated amongst component carriers (CCs) to increase the data throughput between the UEs 101 and the nodes 111a, 111b. For example, UE 101a can communicate with node 111a according to the CCs in CA mode. Furthermore, UE 101a can communicate with nodes 112 in a DC mode simultaneously and additionally communicate with each node of nodes 112 in the CA mode.

In this example, the connections 102 and 104 are illustrated as an air interface to enable communicative coupling. In aspects, the UEs 101 can directly exchange communication data via a ProSe interface 105. The ProSe interface 105 can alternatively be referred to as a sidelink (SL) interface 105 and can comprise one or more logical channels.

The RAN 110 can include one or more access nodes or RAN nodes 111a and 111b (collectively referred to as “RAN nodes 111” or “RAN node 111”) that enable the connections 102 and 104. As used herein, the terms “access node,” “access point,” or the like can describe equipment that provides the radio baseband functions for data and/or voice connectivity between a network and one or more users. These access nodes can be referred to as a base station (BS), next generation base station (gNBs), RAN nodes, evolved next generation base station (eNBs), NodeBs, RSUs, Transmission Reception Points (TRxPs) or TRPs, and so forth.

In aspects where the system 100 is a 5G or NR system, the interface 112 can be an Xn interface 112. The Xn interface is defined between two or more RAN nodes 111 (e.g., two or more gNBs and the like) that connect to 5GC 120, between a RAN node 111 (e.g., a gNB) connecting to 5GC 120 and an eNB, and/or between two eNBs connecting to 5GC 120.

The RAN 110 is shown to be communicatively coupled to a core network-in this aspect, CN 120. The CN 120 can comprise a plurality of network elements 122, which are configured to offer various data and telecommunication services to customers/subscribers (e.g., users of UEs 101) that are connected to the CN 120 via the RAN 110.

In some aspects, physical downlink shared channel (PDSCH) signaling may carry user data and higher layer signaling to UEs 101. The physical downlink control channel (PDCCH) may carry information about the transport format and resource allocations related to the PDSCH channel, among other things. The PDCCH may also inform UEs 101 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN 110 based on channel quality information fed back from any of UEs 101. The downlink resource assignment information may be sent on the PDCCH used for (e.g., assigned to) each of UEs 101.

The BS 111 can generate one or more of the region indication or DCI CCA indication. The BS 111 can subsequently transmit the region indication in a PDSCH message and the DCI CCA indication in a PDCCH message over connections 102 or 104. The BS 111 can receive the initial access message in a RACH message or the UL message after the UE 101 performs a corresponding LBT procedure according to connections 102 or 104. Furthermore, the BS 111 can generate CCA indications in RACH messaging, for example, a RACH message 2 (Msg2), and transmit the CCA indications to the UE 101 over connections 102 or 104.

Regional CCA Signaling with DCI and UE LBT Procedures

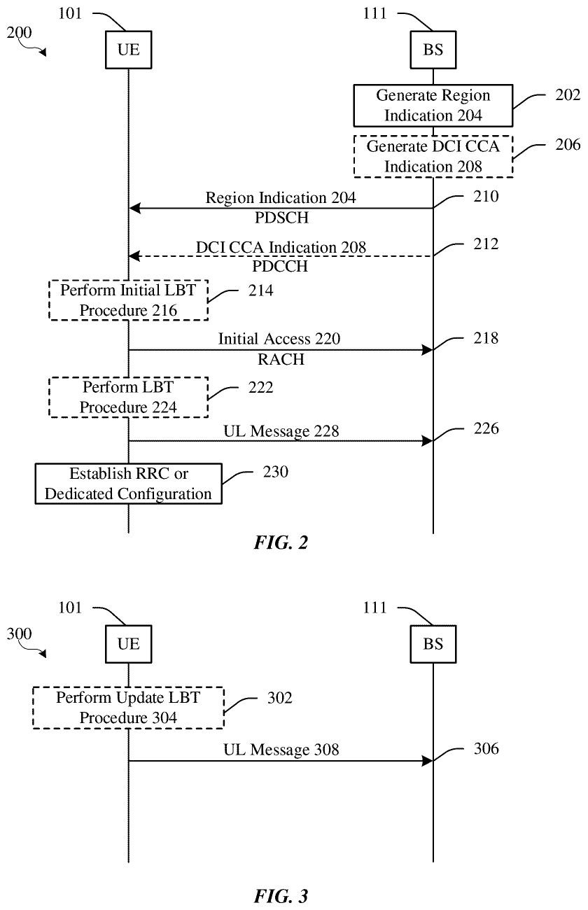

FIG. 2 is a signal flow diagram 200 outlining example signaling for regional clear channel assessment (CCA) signaling and listen before talk (LBT) procedures. In the signal flow diagram 200 a UE 101 receives region information from a BS 111 to perform CCA procedures including LBT procedures associated with the indicated region information to support unlicensed spectrum use. In some aspects, operations described in signal flow diagram 200 are for 60 GHz band (e.g. 57 GHz to 71 GHZ) communications. CCA procedures are employed to determine channel use before conducting communications on a channel. LBT procedures can be employed with License Assisted Access (LAA) technologies to realize unlicensed spectrum use in the presence of other Radio Access Technologies (RATs). As different regions can be regulated by different requirements, signal flow diagram 200 describes signaling and procedures that apply to different regions according to their specific requirements

The BS 111 can coordinate with a NW (e.g. RAN 110, CN 120 of FIG. 1) to determine and generate a region indication 204 at 202. The region indication 204 can indicate one of a first region, a second region, or a third region for CCA procedures.

The first region can correspond to regions where no LBT procedure is required before accessing a channel. As such, LBT procedures can be optional. In other aspects, the first region can correspond to communication operations for licensed bands where LBT operations may not be required. In some aspects, the first region corresponds to CCA procedures regulated by the United States (US) Federal Communications Commission (FCC) or regulated by US standards. In some aspects the first region corresponds to predominantly category 1 (CAT1) operations where a channel is accessed immediately without performing LBT. In other aspects CAT1 operations corresponds to accessing a channel immediately if the channel is accessed during a channel occupancy time (COT). The COT can be a transmit opportunity period (TXOP).

The second region can correspond to regions that predominantly utilize category 3 (CAT3) operations. In some aspects the second region is a region regulated by European standards. Additionally, or alternatively, the second region may be regulated by European Telecommunications Standards Institute (ETSI) EN 302 567. In some aspects, the second region utilize c1, c2, and or c3 bands and associated spectrum access requirements for the 60 GHz band (e.g. 57 GHz to 71 GHZ). The second region may require CAT3 operations according to the CCA operations defined ETSI EN 302 567. In other examples, aspects of the CAT3 procedure for LBT can include performing a CCA check in a channel where the device (e.g. UE 101 or BS 111) does not transmit if the channel is occupied, the device performs CCA using energy detection where transmissions are deferred when the channel is not occupied for a period of time, and where the device schedules transmissions in the channel according to a COT when the channel is clear.

The third region can correspond to regions where LBT procedures are mandatory before every transmission. In some aspects, the LBT procedures mandatory for initial access 220 and/or unlicensed spectrum use generally. In some aspects, the third region can be a region regulated by Japanese standards. The LBT procedures for the third region can be dynamic and can include one or more of a category 2 (CAT2) or CAT3 procedure. The CAT3 procedure can be the CAT3 procedure described in association with the second region. The CAT2 procedure can be a one-step procedure, or a one-shot procedure. The CAT2 procedure can include channel sensing for a period of time, and if the channel is idle during the fixed period of time, the channel can be accessed. If the channel is not idle or clear, then the channel can be sensed again for the period of time at a determined interval. In some aspects, the CAT2 procedure includes a channel check for a period of time (e.g., 5 μs), and if the channel is clear or not occupied during the channel check, then transmission can occur on the channel.

After generating the region indication 204 at 202, the BS 111 can, alternatively or additionally, optionally generate a downlink control indication (DCI) with a DCI CCA indication 208 at 206. The DCI CCA indication 208 can be used by the UE 101 for one or more of initial access 220 with the BS 111, for LBT procedure 224, update LBT procedure 304 (e.g. see FIG. 3). The DCI CCA indication 208 can be optionally generated depending on a communication scheme between the UE 101 and the BS 111. In some aspects, the communication scheme does not make use of a DCI CCA indication, in other aspects, the communication scheme uses the DCI CCA indication to determine LBT procedures. In other aspects, the initial LBT procedure 216 is performed based on the region indication 204 and one or more of the LBT procedure 224 or update LBT procedure 304 (e.g. see FIG. 3) are performed according to the DCI CCA indication 208.

At 210 the BS 111 can transmit a physical downlink shared channel (PDSCH) message including the region indication 204. The BS 111 can generate the region indication 204 in a system information block 1 (SIB1) of the PDSCH message. In some aspects, the region indication 204 is a channel access mode indication, for example, channelAccessMode-r17, in the SIB1. In some aspects, the channelAccessMode-r17 is part of a serving cell common configuration (ServingCellConfigCommon) resource and or a serving cell common SIB configuration (ServingCellConfigCommonSIB) resource of the SIB1. In an alternative aspect, the region indication 204 is transmitted in a radio resource control (RRC) signaling at 210, for example, for a handover procedure.

At 212 the BS 111 can transmit the DCI in a physical downlink control channel (PDCCH) message where the DCI includes the DCI CCA indication 208 if the DCI CCA indication 208 is generated at 206.

At 214 the UE 101 can perform an initial LBT procedure 216 according to the received region indication 204. The initial LBT procedure 216 is performed before the UE 101 transmits an initial access 220 message by, for example, a random access channel (RACH) attempt, for example, a message 1 (Msg1) or message A (MsgA). The UE 101 reads the SIB1 received at 210 and determines the channel access mode indicated by the region indicator 204. The type of initial LBT procedure 216 performed at 214 is dependent on the region indication 204 and can be a no LBT procedure, CAT1, CAT2, or CAT3 procedure.

When the region indication 204 indicates the first region, the UE 101 can directly transmit a RACH transmission at 218 without performing the initial LBT procedure 216. As the first region does not mandate LBT, in some aspects, the UE 101 can skip the initial LBT procedure 216 altogether, as such the UE 101 would not perform the initial LBT procedure 216.

When the region indication 204 indicates the second region, the UE 101 can directly transmit a RACH transmission at 218 without performing the LBT procedure at 214. While the second region may predominantly require CAT3 procedures, for a RACH procedure, the UE 101 can generate the RACH signal as a short control signaling. In some aspects, the short control signaling is as defined in ETSI EN 302 567 and applicable to the second region. In some aspects, the short control signaling are transmissions that occur without sensing the channel for the presence of other signals. The short control signaling can be limited with respect to an observation period (e.g. 100 ms) where short control signaling transmissions are less than 10 ms within an observance period. In some aspects, the UE 101 assumes that the BS 111 does not schedule other transmissions during a time period for the UE 101 to perform RACH Msg1 or MsgA transmissions.

When the region indication 204 indicates the third region, the UE 101 can perform one or more of a CAT2 procedure or a CAT3 procedure as the initial LBT procedure 216 before generating and transmitting the initial access 220 RACH Msg1 or MsgA. In this aspect, the initial LBT procedure 216 is performed as mandated in accordance with third region regulation.

After the UE 101 generates and transmits the initial access 220 message at 218, the UE 101 can perform a LBT procedure 224 at 222 before generating and sending additional UL signaling, for example, UL message 228 at 226. In this aspect, the LBT procedure 224 can be generated based on the DCI CCA indication 208. In some aspects, the DCI CCA indication is comprised in a fallback DCI format. DCI format 0_0 can be a fallback DCI format for uplink resources allocations for the physical uplink shared channel. DCI format 1_0 can be a fallback DCI format for downlink resource allocations for the PDSCH. the LBT procedure 224 associated with a fallback DCI can be performed for signaling after initial access 220, for example at 218, and before connected state signaling, for example, before the UE 101 is in an RRC connected state or dedicated connection at 230. For example, UL message 228 can be a RACH message 3 (Msg3) or other UE 101 UL messaging prior to the RRC connected state or dedicated connection at 230.

In some aspects, a LBT procedure is performed, for example, by the BS 111, prior to the RACH message 2 (Msg2) and RACH message 4 (Msg4) according to a DCI format 1_0 that indicates the DCI CCA indication 208. In this aspect, the BS 111 can perform LBT procedures analogous to LBT procedure 224 prior to generating and transmitting downlink (DL) messaging. In other aspects, the LBT procedure 224 is performed by UE 101 prior to a RACH message 5 (Msg5) according to a DCI format 0_0 that indicates the DCI CCA indication 208. In some aspects the RACH Msg3 LBT mode is communicated in an indicated random access response (RAR) message, like a RACH message 2 (Msg2). In this aspect, the DCI CCA indication 208 can be associated with the RAR message for the RACH Msg2 where the LBT mode indicated in the RAR message is analogous to the discussed DCI CCA indication 208 and is a 0 bit, 1 bit, or 2 bit RAR indication. As such, LBT procedure 224 at 222 can be performed according to a RAR indication rather than the DCI indication. In some aspects, the LBT procedure 224 performed according to the DCI CCA indication 208 can be referred to as a first LBT procedure.

In some aspects, the DCI CCA indication 208 is indicated by CCA bits in the DCI. In other aspects, the DCI CCA indication 208 is indicated without additional CCA bits or without dedicated CCA bits in the DCI, but rather, is indicated by the UE 101 receiving the DCI. In some aspects, LBT procedure 224 associated with the DCI CCA indication 208 are pre-configured and the UE 101 performs the associated procedures after receiving the DCI.

In some examples, where the DCI CCA indication 208 is configured without additional CCA bits in the DCI, the UE 101 can perform LBT procedure 224 based on the region indication 204. For the first region, the UE 101 can generate UL message 228 without performing any LBT procedure. As LBT is not mandatory for the first region, immediate transmissions of UL messaging 228 may be appropriate for the first region. In some aspects, the LBT procedure 224 can be a CAT1 procedure performed before UE 101 generates and transmits UL message 228 at 226.

For the second region, the UE 101 will not perform LBT as part of the LBT procedure 224 before generating UL message 228 when the UE 101 receives the DCI. In this aspect, the BS 111 is responsible for transmitting or scheduling a PUCCH or PUSCH within a COT scheduled by the BS 111. As such, the burden of resource scheduling is placed on the BS 111 thereby allowing the UE 101 to operate without performing a LBT procedure.

In an alternative aspect for the second region, the UE 101 can perform a CAT3 procedure as the LBT procedure 224 before transmitting the UL message 228. In this aspect, the BS 111 would schedule a gap before the UE 101 transmits the UL message 228 so that the UE 101 has time according to the gap to perform the CAT3 procedure.

For the third region, the UE 101 can perform one or more of the CAT2 procedure or the CAT3 procedure as the LBT procedure 224 before generating and transmitting UL message 228 at 226. In this aspect, the CAT2 or CAT3 procedure are performed according to available resource, a pre-configured CAT procedure, or UE 101 implementation.

In some examples, the DCI CCA indication 208 is a one bit CCA indicator. In some examples, the one bit CCA indicator is included in the format 0_0 or format 1_0 of the DCI. As such, the UE 101 can perform the LBT procedure 224 according to a bit value of the one bit CCA indicator. In the first region, the BS 111 can configure the DCI CCA indication 208 one bit indicator to indicate performing no LBT procedure. For example, the one bit CCA indicator can be configured to a 0 value indicating that no LBT procedure is to be performed for the LBT procedure 224 before the UE 101 generates a UL message 228. In other aspects, it does not matter if the BS 111 configures the one bit CCA indicator, or how the BS 111 configures the one bit CCA indicator, since LBT procedures are not mandatory in the first region, the UE 101 can ignore the one bit CCA indicator and perform no LBT procedure at 222 before generating the UL message 228. In some aspects the BS 111 can indicate performing a CAT1 procedure as the LBT procedure 224, or the UE 101 can perform CAT1 as the LBT procedure 224 autonomously regardless of how the one bit CCA indicator is configured.

For the second region, the BS 111 can configure the one bit CCA indicator to indicate performing a CAT3 procedure. For example, the BS 111 can configure the one bit CCA indicator to a value of 1 thereby indicating the CAT3 procedure for the LBT procedure 224. In some aspects, the BS 111 can configure the one bit CCA indicator to indicate performing a CAT1 procedure. For example, the BS 111 can configure the one bit CCA indicator to a value of 0 thereby indicating the CAT1 procedure for the LBT procedure 224. In other aspects, the UE 101 can perform the LBT procedure 224 according to a COT. For example, the BS 111 can configure a COT and the UE 101 can skip performing the LBT procedure 224 or not perform the LBT procedure 224 when the UE 101 can generate and transmit the UL message 228 within the COT. In some aspects, the BS 111 performs a CAT3 procedure acquires and configures the COT while performing the CAT3 procedure. Additionally, the UE 101 can perform the CAT3 procedure as the LBT procedure 224 when the UE 101 determines that the UE 101 will transmit the UL message 228 outside of the COT configured by the BS 111. The UE 101 can be pre-configured to determine LBT procedure 224 according to the COT discussed above, or the BS 111 can configure the UE 101 to follow the COT transmission scheme discussed above according to the one bit CCA indicator.

For the third region, the BS 111 can configure the one bit CCA indicator to indicate performing one or more of the CAT2 or CAT3 procedure. For example, the BS 111 can configure the one bit CCA indicator to a value of 1 thereby indicating one or more of the CAT2 or CAT3 procedure for the LBT procedure 224. In other aspects, the UE 101 can ignore the one bit CCA indicator regardless how it is set and perform one or more of the CAT2 or CAT3 procedure for the LBT procedure 224. In this aspect, the CAT2 or CAT3 procedure are performed according to available resource, a pre-configured CAT procedure, or UE 101 implementation.

In some examples, the DCI CCA indication 208 is a two bit CCA indicator. In some examples, the two bit CCA indicator is included in the format 0_0 or format 1_0 of the DCI. As such, the UE 101 can perform the LBT procedure 224 according to the region indication 204 and a bit value of the two bit CCA indicator. The two bit CCA indicator can indicate no LBT, CAT1, CAT2, or CAT3 procedure for the LBT procedure 224.

In the first region, the BS 111 can configure the two bit CCA indicator for the DCI CCA indication 208 and the UE 101 can perform LBT procedure 224 according to the two bit CCA indicator indicating the no LBT, CAT1, CAT2, or CAT3 procedure. In other aspects, when there is no cell or UE specific RRC configuration indicating that the BS 111 to UE 101 link is operating in a LBT mode, the UE 101 can ignore the two bit CCA indicator regardless how it is set, and the UE 101 can skip performing or not perform a LBT procedure at 222. As such, the LBT procedure 224 is not needed and not performed. In other aspects, when there is no cell or UE specific RRC configuration indicating that the BS 111 to UE 101 link is operating in a LBT mode, the BS 111 sets the two bit CCA indicator to indicate no LBT procedure or a CAT1 procedure for the LBT procedure 224. In other aspects, where the fallback DCI is used after cell specific or UE specific RRC configuration indicating that the BS 111 to UE 101 link is operating in a LBT mode, the BS 111 sets the two bit CCA indicator and the UE 101 performs LBT procedure 224 according to the two bit CCA indicator.

For the second region, the BS 111 can configure the two bit CCA indicator to indicate performing one or more of the no LBT, CAT1, CAT2 or CAT3 procedure and the UE 101 performs LBT procedure 224 according to the two bit CCA indicator. For the third region, the BS 111 can configure the two bit CCA indicator to indicate performing one or more of the CAT2 or CAT3 procedure. In other aspects, the UE 101 can ignore the two bit CCA indicator regardless how it is set and perform one or more of the CAT2 or CAT3 procedure for the LBT procedure 224.

After the UE 101 transmits the UL message 228 at 226, the UE 101 can establish an RRC connection or another dedicated connection according to a dedicated configuration from the BS 111 at 230. After the UE 101 is in an RRC connected state or other dedicated connection, the UE 101 can change or upgrade the LBT procedure for subsequent UL messaging.

FIG. 3 is a signal flow diagram 300 outlining example signaling for regional clear channel assessment (CCA) signaling and updated listen before talk (LBT) procedures after a UE 101 establishes a connection with a BS 111. Aspects of signal flow diagram 300 can occur after the aspects of signal flow diagram 200 of FIG. 2, in other examples, aspects of signal flow diagram 300 can occur after alternative signaling. Aspects of signal flow diagram 300 corresponds to CCA signaling according to the first, second, or third regions described previously. Signal flow diagram 300 describes an update LBT procedure 304 performed by the UE 101 at 302 where the UE 101 can update or upgrade to a LBT procedure that is different than the LBT procedure 224 or initial LBT procedure 216 of FIG. 2. The update LBT procedure 304 can be referred to as a second LBT procedure. The update LBT procedure 304 can be associated with the DCI CCA indication 208 of FIG. 2 or based on a non-scheduling DCI format like a DCI format 2_0 according to a COT, or a DCI indication of a DCI that is different than the DCI associated with the DCI CCA indication 208, or a combination of the above. The update LBT procedure 304 can correspond to a LBT procedure according to a non-fallback DCI format. For example, the update LBT procedure 304 can correspond to a LBT procedure other than a format 0_0 or format 1_0, or according to a format 0_1, format 0_2, format 1_1, format 1_2, or the like. The DCI format 2_0 can indicate the update LBT procedure 304 according to a COT time indicated by the BS 111. As such, the DCI format 2_0 is a non-scheduling group DCI that is absent PDSCH or PUSCH scheduling information. Rather, the UE 101 determines if UL message 308 can be transmitted within a COT time indicated by the format 2_0 and optionally upgrade the LBT procedure that may have been indicated by the DCI CCA indication 208. The following aspects describe update LBT procedure 304 before sending UL message 308 and after the UE 101 establishes a RRC or dedicated connection with BS 111.

In the first region, the UE 101 can follow one or more RRC configured CCA bits in a non-fallback DCI to perform no LBT, CAT1, CAT2, or CAT3 procedure for the update LBT procedure 304. The UE 101 will configure update LBT procedure 304 when the UE 101 is configured by RRC for a LBT link with the BS 111. The RRC configuration can be cell specific or UE 101 specific. In other examples, the upgrade process for the first region can follow the upgrade procedure described below for the second region.

In the first region or the second region, the UE 101 can be configured with a two bit CCA indicator in a DCI format. For example, the first LBT procedure can be configured by a two bit CCA indicator comprised in a non-fallback or fallback DCI. The two bit CCA indicator can indicate a CAT1, CAT2, or CAT3 procedure. When the UE 101 configured for the first region or the second region is configured with the two bit CCA for the first LBT procedure, the UE 101 can utilize various upgrade options. In some aspects, the UE 101 can autonomously update or upgrade the DCI indicated or RRC indicated CAT type to another CAT type if the UE 101 determines that the UL message 308 at 306 can be transmitted within a COT configured by the BS 111. The UE 101 can detect the COT in a detected DCI format 2_0.

A first upgrade option corresponds to examples where the UE 101 configures the CAT3 procedure for the first LBT procedure based on a two bit CCA indicator and the update LBT procedure 304 is a CAT1 procedure. In this example, the UE 101 can detect a COT configured by the BS 111 in a DCI format 2_0 of a DCI. The UE 101 can determine that the UL message 308 can be generated and transmitted within the COT configured by the BS 111. Subsequently, the UE 101 can upgrade from the configured CAT3 procedure to the CAT1 procedure for the updated LBT procedure 304 in response to determining that the UL message 308 can be transmitted within the COT. The CAT3 procedure requires more time and resources to perform compared to the CAT 1 procedure, as such, by upgrading to the CAT 1 procedure, the UE 101 is able to transmit the UL message 308 sooner. The UE 101 performs the CAT1 procedure for the update LBT procedure 304 at 302 and transmits the UL message 308 at 306 within the COT.

A second upgrade option corresponds to examples where the UE 101 configures the CAT3 procedure for the first LBT procedure based on a two bit CCA indicator and the update LBT procedure 304 is a CAT2 procedure. In this example, the UE 101 can detect a COT configured by the BS 111 in a DCI format 2_0 of a DCI. The UE 101 can determine that the UL message 308 can be generated and transmitted within the COT configured by the BS 111. Subsequently, the UE 101 can upgrade from the configured CAT3 to the CAT2 procedure for the update LBT procedure 304 in response to determining that the UL message 308 can be transmitted within the COT. The CAT3 procedure requires more time and resources to perform compared to the CAT2 procedure, as such, by upgrading to a CAT2 procedure, the UE 101 is able to transmit the UL message 308 sooner. The UE 101 performs the CAT2 procedure for the update LBT procedure 304 at 302 and transmits the UL message 308 at 306 within the COT.

A third upgrade option corresponds to examples where the UE 101 configures the CAT2 procedure for the first LBT procedure based on a two bit CCA indicator and the update LBT procedure 304 is a CAT1 procedure. In this example, the UE 101 can detect a COT configured by the BS 111 in a DCI format 2_0 of a DCI. The UE 101 can determine that the UL message 308 can be generated and transmitted within the COT configured by the BS 111. Subsequently, the UE 101 can upgrade from the configured CAT2 to the CAT1 procedure for the update LBT procedure 304 in response to determining that the UL message 308 can be transmitted within the COT. The CAT2 procedure requires more time and resources to perform compared to the CAT1 procedure, as such, by upgrading to a CAT1 procedure, the UE 101 is able to transmit the UL message 308 sooner. The UE 101 performs the CAT1 procedure for the update LBT procedure 304 at 302 and transmits the UL message 308 at 306 within the COT.

In the first region or the second region, the UE 101 can be configured with a one bit CCA indicator in a DCI format rather than the two bit CCA indicator. For example, the first LBT procedure can be configured by a one bit CCA indicator comprised in a non-fallback or fallback DCI. The one bit CCA indicator can indicated a CAT1 or CAT3 procedure. When the UE 101 configured for the first region or the second region is configured with the one bit CCA for the first LBT procedure, the UE 101 can autonomously update or upgrade the DCI indicated or RRC indicated CAT type to another CAT type if the UE 101 determines that the UL message 308 at 306 can be transmitted within a COT configured by the BS 111. The UE 101 can detect the COT in a detected DCI format 2_0.

For example, the UE 101 can configure the CAT3 procedure for the first LBT procedure based on the one bit CCA indicator and the update LBT procedure 304 can be a CAT1 procedure. In this example, the UE 101 can detect a COT configured by the BS 111 in a DCI format 2_0 of a DCI. The UE 101 can determine that the UL message 308 can be generated and transmitted within the COT configured by the BS 111. Subsequently, the UE 101 can upgrade from the configured CAT3 procedure to the CAT1 procedure for the update LBT procedure 304 in response to determining that the UL message 308 can be transmitted within the COT. The CAT3 procedure requires more time and resources to perform compared to the CAT1 procedure, as such, by upgrading to the CAT1 procedure, the UE 101 is able to transmit the UL message 308 sooner. The UE 101 performs the CAT1 procedure for the update LBT procedure 304 at 302 and transmits the UL message 308 at 306 within the COT.

In the third region, the UE 101 can configure the update LBT procedure 304 according to various examples. In a first example, the BS 111 configures no bits in a CCA indicator. In this aspect, there may be no bits in the DCI to configure for CCA indication, as was discussed in accordance with FIG. 2 where the communication scheme between the UE 101 and the BS 111 does not make use of the CCA indication. In other aspects, the communication scheme between the UE 101 and the BS 111 does make use of the CCA indication, but the BS 111 does not configure any bits for CCA indication. When there are no BS 111 configured bits in the CCA indicator, the UE 101 can perform a CAT2 procedure for the update LBT procedure 304 at 302 and transmit the UL message 308 at 306 after performing the CAT2 procedure.

In a second example for the third region, the BS 111 configures one bit in a CCA indication in a non-fall back or fall back DCI. As such, the first LBT procedure can be either a CAT2 or CAT3 procedure. In some aspects, UE 101 configures the CAT3 procedure for the first LBT procedure based on the one bit CCA indicator and the update LBT procedure 304 is a CAT2 procedure. In this example, the UE 101 can detect a COT configured by the BS 111 in a DCI format 2_0 of a DCI. The UE 101 can determine that the UL message 308 can be generated and transmitted within the COT configured by the BS 111. Subsequently, the UE 101 can upgrade from the configured CAT3 to the CAT2 procedure for the update LBT procedure 304 in response to determining that the UL message 308 can be transmitted within the COT. The CAT3 procedure requires more time and resources to perform compared to the CAT2 procedure, as such, by upgrading to a CAT2 procedure, the UE 101 is able to transmit the UL message 308 sooner. The UE 101 performs the CAT2 procedure for the update LBT procedure 304 at 302 and transmits the UL message 308 at 306 within the COT.

Aspects described above corresponding to FIG. 3 provide various options for the update or upgrade behavior of the update LBT procedure 304 according to various factors in different regions. Examples described above enable the UE 101 to change the LBT procedure to a LBT procedure that may be faster and more efficient for the second LBT procedure when compared to the first LBT procedure or the initial LBT procedure 216.

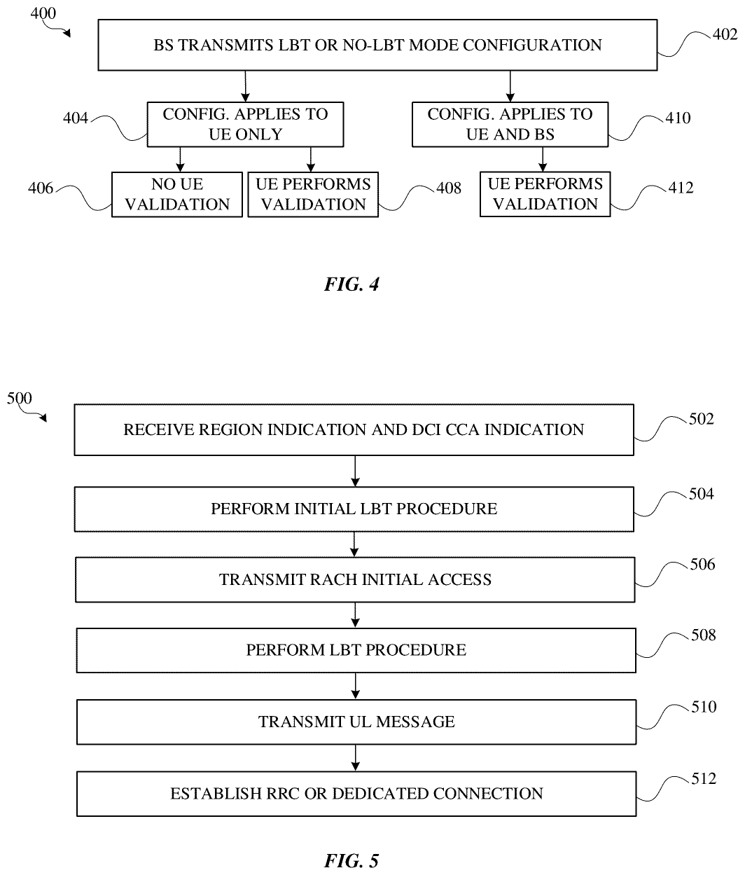

FIG. 4 illustrates a flow diagram of an example method 400 for BS 111 to UE 101 LBT mode configuration for regions where LBT is not mandated. The example method 400 shows various mode configuration indication options where the mode configuration indication applies to the UE 101 only or to both the UE 101 and the BS 111. In the first region LBT procedures are not mandatory however, the core network 120 or BS 111 may determine that LBT procedures should be followed for unlicensed spectrum use based on network conditions. For example, the BS 111 may determine that channel conditions may result in unreliable communications for coexisting unlicensed operations and other RATs. In such an example, the BS 111 may indicate the mode configuration indication for LBT procedures even though LBT procedures are not mandated for the first region. In other examples, the UE 101 and BS 111 may be preconfigured to enable LBT procedures when certain network or channel conditions are met that would improve overall system performance, for example to mitigate or eliminate unlicensed spectrum use that could interfere with other RATs.

In the first region where LBT procedures are not mandatory, the BS 111 can indicate to the UE 101 that the UE 101 to BS 111 connection is operating in a LBT operation or a no LBT operation. The UE 101 can then configure operations for the first region based on the indication from the BS 111. In some examples, the LBT mode configuration can be indicated in a SIBx (e.g. SIB1, SIB2, etc.) or RRC signaling. As such, the BS 111 signals a LBT mode configuration that indicates the connection is a LBT connection (e.g. LBT operation) or a connection that is not a LBT connection (e.g. no LBT operation). The BS 111 can signal a cell specific configuration or UE specific configuration for the LBT mode configuration. For example, for a cell specific indication, the LBT mode configuration is common for all UEs in a cell. The LBT mode configuration can be part of a signaled system information or dedicated RRC signaling or both, and the LBT mode configuration can apply to all UEs in the cell. In other examples, for UE specific indication, the LBT mode configuration can apply to specific UEs in the cell. As such, different UEs in the cell can receive a different LBT mode configuration. The BS 111 can transmit the UE specific indication as part of a UE specific RRC configuration.

Accordingly, at 402 the BS 111 can transmit the LBT mode configuration indicating the LBT operation or a no LBT operation for the BS 111 to UE 101 connection. The LBT mode configuration can apply to a cell or a specific UE. In some aspects, the LBT mode configuration that indicates the LBT operation or the no LBT operation applies to the UE 101 only as shown at 404. The UE 101 can determine a validation scheme and whether to perform validation of BS 111 transmissions as shown at 408 or not to perform validation of BS 111 transmissions as shown at 406. Performing validation of BS 111 transmissions can include the UE 101 affirmatively confirming that the BS 111 transmitted an expected message. In this aspect, if the UE expects to receive a message or for the BS 111 to transmit or broadcast a message, and the UE does not detect the expected message, then the UE 101 can perform a validation fallback procedure according to pre-configured instructions as part of an LBT procedure. For example, the UE 101 can validate a periodic channel state information reference signal (p-CSI-RS) signal from the BS 111. The P-CSI-RS can be used by the UE 101 for link adaptation, multiple input multiple output (MIMO) feedback, radio resource management (RRM) or radio link monitoring (RLM) management. As such, the UE 101 may ensure the p-CSI-RS is transmitted through validation before using the p-CSI-RS for feedback or other procedures. If the UE 101 does not perform the validation, then the UE 101 may perform improper feedback procedures.

In some examples the UE 101 determines whether to perform validation based on a validation indication from the BS 111. In other aspects, the UE 101 is pre-configured to perform or not to preform validation of BS 111 transmissions.

For example, at 406 the LBT mode configuration indicates the no LBT operation and applies only to the UE 101 and the UE 101 does not perform validation of BS 111 signaling. In some examples, the UE 101 can assume that the BS 111 will not perform any LBT operations. In some aspects, the BS 111 can frequency division multiplex (FDM) multiple different UEs together with or without LBT configurations so that the BS 111 can implement flexible UL and downlink (DL) scheduling. In this example, the UE 101 can assume that the BS 111 always transmits PDCCH, PDSCH, or p-CSI-RS according to scheduled resources or triggering events. Thus UE 101 will not perform validation on whether a PDCCH, PDSCH, or p-CSI-RS is transmitted by the BS 111 since the UE 101 assumes they are always sent according to scheduled resources. In some aspects, the UE 101 will always assume the BS 111 performs transmissions appropriate to a no LBT operation. The BS 111 can determine whether or not to perform a LBT procedures at 406 according to scheduled resources, network conditions, or triggering events. Since the UE 101 does not perform validation, there is low cost of resources to the UE 101. As such, the UE 101 does not perform validation in response to receiving the LBT mode configuration.

In another example, at 408, the LBT mode configuration indicates the LBT operation and applies only to the UE 101 and the UE 101 performs validation of BS 111 signaling. In this aspect, the UE 101 always assumes the BS 111 performs a LBT procedure. As such, the UE 101 will perform validation of BS 111 signaling, for example, p-CSI-RS signaling from the BS 111. In this aspect, the BS 111 can determine whether or not to perform a LBT procedure at 408. This example is a higher cost of resources to the UE 101 as the UE 101 is performing validation. In this example, the UE 101 may need updated resource information from the p-CSI-RS for further signaling. As such, communications with the BS 111 may be unreliable if the p-CSI-RS is not transmitted by the BS 111 to the UE 101. In some situations, the BS 111 May transmit the p-CSI-RS and the UE 101 may not receive the P-CSI-RS due to network congestion or interference. By the UE 101 performing validation, reliability of communications between the UE 101 and BS 111 can be improved.

In another example, at 410, the LBT mode configuration indicates the LBT operation and applies to both the UE 101 and the BS 111 and the UE 101 performs validation of BS 111 signaling at 412, and the BS 111 performs LBT procedures. In this aspect, the UE 101 assumes the BS 111 performs a LBT procedure. As such, the UE 101 will perform validation of BS 111 signaling at 412, for example, validation of p-CSI-RS signaling from the BS 111. In this aspect, the BS 111 will perform a LBT procedure at 410. The BS 111 can perform the LBT procedure for all FDM transmissions of LBT and no LBT communication links. This example is a higher cost of resources to both the UE 101 and BS 111 as the UE 101 is performing validation and the BS 111 is performing the LBT procedure, however this example ensures the most reliable communication link. As described above, the BS 111 may transmit the p-CSI-RS and the UE 101 may not receive the P-CSI-RS due to network congestion or interference. By the UE 101 performing validation, reliability of communications between the UE 101 and BS 111 can be improved.

FIG. 5 illustrates a flow diagram of an example method 500 for regional CCA signaling and LBT procedures of a UE. The example method 500 may be performed, for example by the UE 101 of FIG. 2.

At 502, the method includes receiving a region indication and optionally receiving a DCI CCA indication. FIG. 2 at 210 and 212 corresponds to some aspects of act 502.

At 504, the method includes performing an initial LBT procedure according to the region indication. FIG. 2 at 214 corresponds to some aspects of act 504.

At 506, the method includes transmitting an initial access RACH message after performing the initial LBT procedure. FIG. 2 at 218 corresponds to some aspects of act 506.

At 508, the method includes performing a LBT procedure according to the DCI CCA indication if the DCI CCA indication is received at 502. FIG. 2 at 222 corresponds to some aspects of act 508.

At 510, the method includes transmitting a UL message after performing the LBT procedure at 508. FIG. 2 at 226 corresponds to some aspects of act 510.

At 512, the method includes establishing a RRC connection or dedicated connection after transmitting the initial access RACH message at 506. FIG. 2 at 230 corresponds to some aspects of act 512.

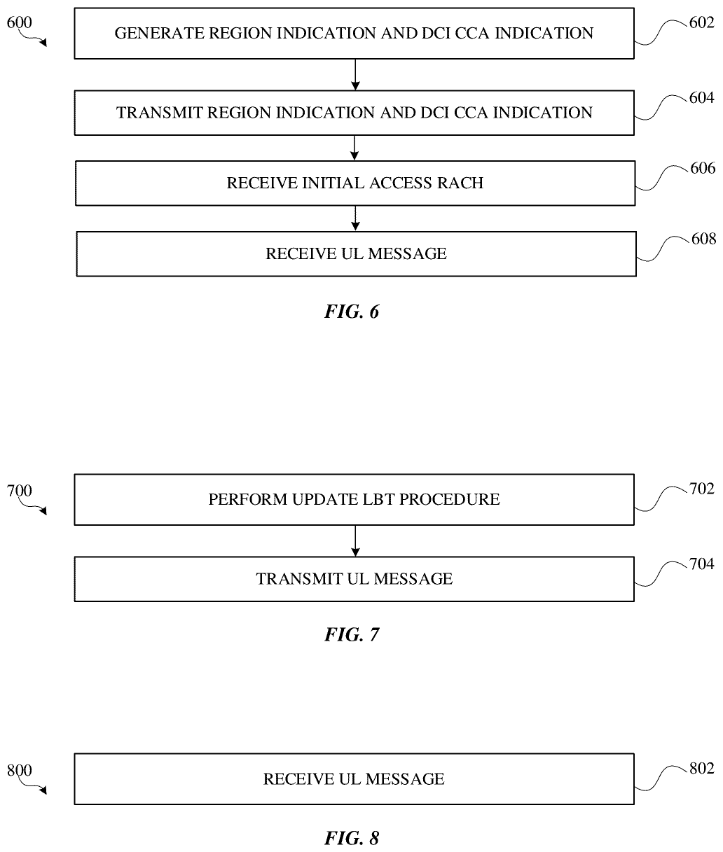

FIG. 6 illustrates a flow diagram of an example method 600 for regional CCA signaling and LBT procedures of a BS. The example method 600 may be performed, for example by the BS 111 of FIG. 2.

At 602, the method includes generating a region indication and optionally generating a DCI CCA indication. FIG. 2 at 202 and 206 corresponds to some aspects of act 602.

At 604, the method includes transmitting the region indication and the DCI CCA indication. FIG. 2 at 210 and 212 corresponds to some aspects of act 604.

At 606, the method includes receiving an initial access RACH message after transmitting the region indication. FIG. 2 at 218 corresponds to some aspects of act 606.

At 608, the method includes receiving a UL message after receiving the initial access RACH message. FIG. 2 at 226 corresponds to some aspects of act 608.

FIG. 7 illustrates a flow diagram of an example method 700 for CCA signaling corresponding to updated LBT procedures by a UE. The example method 700 may be performed, for example by the UE 101 of FIG. 3.

At 702, the method includes performing an update LBT procedure according to pre-configured instructions or CCA bits in a DCI. In some aspects, act 702 occurs after the UE establishes a dedicated connection. FIG. 3 at 302 corresponds to some aspects of act 702.

At 704, the method includes transmitting a UL message after performing the update LBT procedure. FIG. 3 at 306 corresponds to some aspects of act 704.

FIG. 8 illustrates a flow diagram of an example method 800 for CCA signaling corresponding to updated LBT procedures by a BS. The example method 800 may be performed, for example by the BS 111 of FIG. 3.

At 802, the method includes receiving a UL message after generating one or more of a region indication or a DCI CCA indication and establishing a dedicated connection with a UE. FIG. 3 at 306 corresponds to some aspects of act 802.

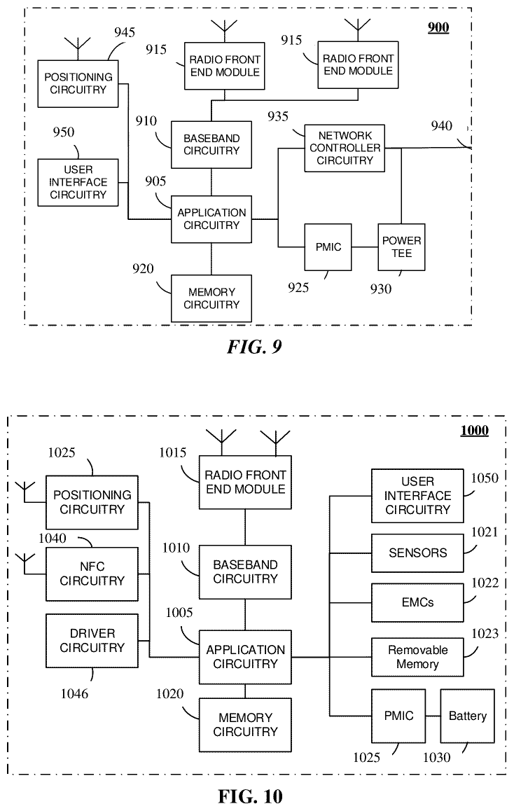

FIG. 9 illustrates an example of infrastructure equipment 900 in accordance with various aspects. The infrastructure equipment 900 (or “system 900”) may be implemented as a base station, radio head, RAN node such as the BS 111 of FIG. 1 and/or any other element/device discussed herein. In other examples, the system 900 could be implemented in or by a UE such as UE 101 of FIG. 1. In yet other aspects, some features of the system 900 could be implemented in or by a AMF such as the AMF 124 of FIG. 1

The system 900 includes application circuitry 905, baseband circuitry 910, one or more radio front end modules (RFEMs) 915, memory circuitry 920 (including a memory interface), power management integrated circuitry (PMIC) 925, power tee circuitry 930, network controller circuitry 935, network interface connector 940, satellite positioning circuitry 945, and user interface 950. In some aspects, the device of system 900 may include additional elements such as, for example, memory/storage, display, camera, sensor, or input/output (I/O) interface. In other aspects, the components described below may be included in more than one device. For example, said circuitries may be separately included in more than one device for CRAN, vBBU, or other like implementations.

The baseband circuitry 910 can be used to generate and transmit one or more of region indication 204 or DCI CCA indication 208, mode configuration, RRC configurations, dedicated configuration, or other signaling from the BS 111 described herein. Baseband circuitry 910 can be used to receive one or more of the initial access 220 RACH message, UL message 228, UL message 308 or other signaling for the BS 111 described herein. Baseband circuitry 910 can be used to generate and transmit one or more of the initial access 220 RACH message, UL message 228, or UL message 308 by the UE 101. Baseband circuitry 910 can be used to receive one or more of the region indication 204, DCI CCA indication 208, RRC configurations, mode configurations, RRC configurations, dedicated configuration, or other signaling for the UE 101.

Application circuitry 905 includes circuitry such as, but not limited to one or more processors (or processor cores), processing circuitry, cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 905 may be coupled with or may include memory/storage elements and may be configured to execute instructions stored in the memory/storage to enable various applications or operating systems to run on the system 900. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein. Application circuitry 905 can generate and or facilitate updating one or more of the initial LBT procedure 216, LBT procedure 224, or update LBT procedure 304 for the UE 101. Application circuitry 905 can generate the region indication 204, DCI CCA indication 208, mode configuration, RRC configuration, or dedicated configuration for the BS 111. Memory circuitry 920 can store one or more of the initial LBT procedure 216, LBT procedure 224, update LBT procedure 304, region indication 204, DCI CCA indication 208, or the like for the UE 101.

The processor(s) of application circuitry 905 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some aspects, the application circuitry 905 may comprise, or may be, a special-purpose processor/controller to operate according to the various aspects herein. As examples, the processor(s) of application circuitry 905 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some aspects, the system 900 may not utilize application circuitry 905, and instead may include a special-purpose processor/controller to process IP data received from an EPC or 5GC, for example.

User interface 950 may include one or more user interfaces designed to enable user interaction with the system 900 or peripheral component interfaces designed to enable peripheral component interaction with the system 900. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The components shown by FIG. 9 may communicate with one another using interface circuitry, that is communicatively coupled to one another, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an 12C interface, an SPI interface, point to point interfaces, and a power bus, among others.

FIG. 10 illustrates an example of a platform 1000 (or “device 1000”) in accordance with various aspects. In aspects, the platform 1000 may be suitable for use as the UE 101 of FIG. 1, and/or any other element/device discussed herein such as the BS 111 or AMF 124 of FIG. 1. The platform 1000 may include any combinations of the components shown in the example. The components of platform 1000 may be implemented as integrated circuits (ICs), portions thereof, discrete electronic devices, or other modules, logic, hardware, software, firmware, or a combination thereof adapted in the platform 1000, or as components otherwise incorporated within a chassis of a larger system. The block diagram of FIG. 10 is intended to show a high level view of components of the platform 1000. However, some of the components shown may be omitted, additional components may be present, and different arrangement of the components shown may occur in other implementations.

Application circuitry 1005 includes circuitry such as, but not limited to one or more processors (or processor cores), memory circuitry 1020 (which includes a memory interface), cache memory, and one or more of LDOs, interrupt controllers, serial interfaces such as SPI, 12C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 1005 may be coupled with or may include memory/storage elements and may be configured to execute instructions stored in the memory/storage to enable various applications or operating systems to run on the system 1000. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

Application circuitry 1005 can generate and or facilitate updating one or more of the initial LBT procedure 216, LBT procedure 224, or update LBT procedure 304 for the UE 101. Application circuitry 905 can generate the region indication 204, DCI CCA indication 208, mode configuration, RRC configuration, or dedicated configuration for the BS 111. Memory circuitry 1020 can store one or more of the initial LBT procedure 216, LBT procedure 224, update LBT procedure 304, region indication 204, DCI CCA indication 208, or the like for the UE 101.

As examples, the processor(s) of application circuitry 1005 may include a general or special purpose processor, such as an A-series processor (e.g., the A13 Bionic), available from Apple® Inc., Cupertino, CA or any other such processor. The processors of the application circuitry 1005 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 1005 may be a part of a system on a chip (SoC) in which the application circuitry 1005 and other components are formed into a single integrated circuit, or a single package.

The baseband circuitry or processor 1010 may be implemented, for example, as a solder-down substrate including one or more integrated circuits, a single packaged integrated circuit soldered to a main circuit board or a multi-chip module containing two or more integrated circuits. Furthermore, the baseband circuitry or processor 1010 may cause transmission of various resources. The baseband circuitry 1010 can be used to generate and transmit one or more of region indication 204 or DCI CCA indication 208, mode configuration, RRC configurations, dedicated configuration, or other signaling from the BS 111 described herein. Baseband circuitry 1010 can be used to receive one or more of the initial access 220 RACH message, UL message 228, UL message 308 or other signaling for the BS 111 described herein. Baseband circuitry 1010 can be used to generate and transmit one or more of the initial access 220 RACH message, UL message 228, or UL message 308 by the UE 101. Baseband circuitry 1010 can be used to receive one or more of the region indication 204, DCI CCA indication 208, RRC configurations, mode configurations, RRC configurations, dedicated configuration, or other signaling for the UE 101.

The platform 1000 may also include interface circuitry (not shown) that is used to connect external devices with the platform 1000. The interface circuitry may communicatively couple one interface to another. The external devices connected to the platform 1000 via the interface circuitry include sensor circuitry 1021 and electro-mechanical components (EMCs) 922, as well as removable memory devices coupled to removable memory circuitry 923.

A battery 1030 may power the platform 1000, although in some examples the platform 1000 may be mounted deployed in a fixed location, and may have a power supply coupled to an electrical grid. The battery 1030 may be a lithium ion battery, a metal-air battery, such as a zinc-air battery, an aluminum-air battery, a lithium-air battery, and the like. In some implementations, such as in V2X applications, the battery 1030 may be a typical lead-acid automotive battery.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a computer readable medium or a non-transitory computer readable medium using instructions stored in a memory. Many other examples and variations are possible within the scope of the claimed disclosure.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units. The processor or baseband processor can be configured to execute instructions described herein.

A UE or a BS, for example the UE 101 or BS 111 of FIG. 1 can comprise a memory interface and processing circuitry communicatively coupled to the memory interface configured to execute instructions described herein.

Examples (aspects) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to aspects and examples described herein.

Example 1 is a baseband processor of a user equipment (UE), comprising: one or more processors configured to: receive system information comprising a region indication for clear channel assessment (CCA) procedures associated with a listen before talk (LBT) region configuration for one of a first region, a second region, or a third region, and receive a downlink control information (DCI) in a physical downlink control channel (PDCCH) message comprising a DCI CCA indication; perform an initial LBT procedure associated with the region indication and generate a random access channel (RACH) message after performing the initial LBT procedure; generate an uplink (UL) message according to the DCI CCA indication.

Example 2 can include Example 1, wherein LBT operations are not mandated in the first region, LBT operations are associated with at least some regulation in the second region, and wherein LBT is mandatory in the third region.

Example 3 can include Example 2, wherein the first region is further regulated by United States standards, second region is regulated by European standards and by ETSI EN 302 567, and the third region is regulated by Japanese standards.

Example 4 can include Example 1, wherein the region indication is comprised in a channelAccessMode-r17 resource which is comprised in a ServingCellConfigCommon resource or ServingCellConfigCommonSIB resource.

Example 5 can include Example 1, wherein the SIB1 comprising the region indication is received in a radio resource control (RRC) message.

Example 6 can include Example 1, wherein the processors are further configured to establish a RRC connection after receiving the DCI CCA indication.

Example 7 can include Example 1, wherein the region indication indicates the first region or the second region and the initial LBT procedure is a no LBT procedure, and the processors are configured to: generate the Msg1 or the MsgA without performing a LBT procedure before generating the Msg1 or the MsgA.

Example 8 can include Example 7, wherein the Msg1 or MsgA are generated as short control signaling in the second region.

Example 9 can include Example 1, wherein the region indication indicates the third region and the initial LBT procedure is one or more of a category 2 (CAT2) procedure or CAT3 procedure, and the processors are configured to: perform one or more of the CAT2 procedure or CAT3 procedure; and generate a RACH message after performing one or more of the CAT2 procedure or CAT3 procedure.

Example 10 can include Example 1, wherein the region indication indicates the first region or the second region and the DCI CCA indication indicates a no LBT procedure and the processors are configured to: generate the UL message without performing a LBT procedure in response to the DCI CCA indication.

Example 11 can include Example 1, wherein the region indication indicates the first region or the second region and wherein the processors are further configured to: receive a random access response (RAR) message with a CCA indication wherein the CCA indication is 0, 1, or 2 bits; perform a LBT procedure according to the CCA indication; and generate the UL message in response performing the LBT procedure.

Example 12 can include Example 1, wherein the region indication indicates the second region and the DCI CCA indication indicates a CAT3 procedure and the processors are configured to: perform the CAT3 procedure; and generate the UL message after performing the CAT3 procedure.

Example 13 can include Example 1, wherein the region indication indicates the third region and the DCI CCA indication indicates one or more of a CAT2 procedure or a CAT3 procedure and the processors are configured to: perform one or more of the CAT2 procedure or the CAT3 procedure; and generate the UL message after performing one or more of the CAT2 procedure or the CAT3 procedure.

Example 14 can include any of Examples 10-13, wherein the DCI CCA indication is the received DCI without any dedicated CCA bits.

Example 15 can include Example 1, wherein the region indication indicates the first region and the DCI CCA indication is a one bit CCA indicator that indicates a no LBT procedure and the processors are configured to: generate the UL message without performing a LBT operation.

Example 16 can include Example 1, wherein the region indication indicates the second region and the DCI CCA indication is a one bit CCA indicator that indicates a CAT3 procedure or a no LBT procedure and the processors are configured to: perform the CAT3 procedure or perform no LBT procedure according to the one bit CCA indicator; and generate the UL message after performing the CAT3 procedure or performing no LBT procedure.

Example 17 can include Example 1, wherein the region indication indicates the third region and the DCI CCA indication is a one bit CCA indicator that indicates a CAT2 procedure or a CAT3 procedure and the processors are configured to: perform the CAT2 procedure or the CAT3 procedure; and generate the UL message after performing the CAT2 procedure or the CAT3 procedure.

Example 18 can include Example 1, wherein the DCI CCA indication is a two bit CCA indicator comprised in a DCI format 0_0 or a DCI format 1_0 and indicates a category 1 (CAT1) procedure, CAT2 procedure, or a CAT3 procedure and the processors are configured to: perform one of the CAT1, CAT2, or CAT3 procedure; and generate the UL message after performing one of the CAT1, CAT2, or CAT3 procedure.

Example 19 can include Example 18, wherein one of the CAT1, CAT2, or CAT3 procedure is performed after establishing a cell specific or UE specific RRC connection.

Example 20 can include any of Examples 1-19, wherein the region indication is associated with 60 GHz band wireless operations.

Example 21 is a baseband processor of a user equipment (UE), comprising: one or more processors configured to: receive a system information block 1 (SIB1) comprising a region indication for clear channel assessment (CCA) procedures associated with a listen before talk (LBT) configuration for one of a first region, a second region, or a third region, and receive a downlink control information (DCI) in a physical downlink control channel (PDCCH) message, wherein LBT operations are not mandated in the first region, LBT operations are associated with at least some regulation in the second region, and LBT is mandatory in the third region; configure a first LBT procedure according to a fallback DCI format of the DCI; configure a second LBT procedure according to a DCI format of the DCI; and generate an uplink (UL) message after performing the second LBT procedure.

Example 22 can include Example 21, wherein the region indication indicates the first region and the processors are configured to: receive radio resource control (RRC) signaling indicating a LBT connection and a RRC configured DCI with CCA bits wherein the CCA bits are associated with a non-fallback DCI format; and the CCA bits indicate a category 1 (CAT1), a category 2 (CAT2), or a CAT3 procedure for the second LBT procedure.

Example 23 can include Example 21, wherein the region indication indicates the first region or the second region and the DCI format includes a two bit CCA indicator.

Example 24 can include Example 23, wherein the first LBT procedure is a CAT3 procedure and the processors are configured to: detect a channel occupancy time (COT) in a format 2_0; perform the second LBT procedure according to a category 1 (CAT1) procedure; and generate the UL message during the COT.

Example 25 can include Example 23, wherein the first LBT procedure is a CAT3 procedure and the processors are configured to: detect a channel occupancy time (COT) in a format 2_0; perform the second LBT procedure according to a category 2 (CAT2) procedure; and generate the UL message during the COT.

Example 26 can include Example 23, wherein the first LBT procedure is a category 2 (CAT2) procedure and the processors are configured to: detect a channel occupancy time (COT) in a format 2_0; perform the second LBT procedure according to a category 1 (CAT1) procedure; and generate the UL message during the COT.

Example 27 can include Example 21, wherein the region indication indicates the first region or the second region and the DCI format includes a one bit CCA indicator wherein the first LBT procedure is a CAT3 procedure and the processors are configured to: detect a channel occupancy time (COT) in a format 2_0; determine that the UL message can be generated during the COT; configure the second LBT procedure according to a category 1 (CAT1) procedure; and generate the UL message during the COT.

Example 28 can include Example 21, wherein the region indication indicates the third region and wherein the first LBT procedure and the second LBT procedure are a category 2 (CAT2) procedure as indicated by the DCI format.

Example 29 can include Example 28, wherein the received DCI does not include dedicated CCA bits.

Example 30 can include Example 21, wherein the region indication indicates the third region and the DCI format includes a one bit CCA indicator wherein the first LBT procedure is a CAT3 procedure and the processors are configured to: detect a channel occupancy time (COT) in a format 2_0; configure the second LBT procedure according to a category 2 (CAT2) procedure; and generate the UL message during the COT.

Example 31 is a baseband processor of a user equipment (UE), comprising: one or more processors configured to: configure operations for a listen before talk (LBT) region where LBT is mandatory and receive a LBT mode configuration that indicates a LBT operation or a no LBT operation for a Base Station (BS), where the LBT mode configuration is a cell specific configuration or UE specific configuration; and determine a validation scheme for BS signaling based on the LBT mode configuration.

Example 32 can include Example 31, wherein the LBT mode configuration is received in one or more of a system information or a radio resource control (RRC) signaling.

Example 33 can include Example 31, wherein the LBT mode configuration indicates the no LBT operation for the BS; and the one or more processors are configured to determine the validation scheme wherein BS signaling is not validated in response to the indicated no LBT operation for the BS.

Example 34 can include Example 31, wherein the LBT mode configuration indicates the LBT operation for the BS; and the one or more processors are configured to determine the validation scheme wherein BS signaling is validated in response to the indicated LBT operation for the BS.

Example 35 can include Example 35, wherein the one or more processors are configured to validate reception of a periodic channel state information reference signal (p-CSI-RS).

A method as substantially described herein with reference to each or any combination substantially described herein, comprised in examples 1-35, and in the Detailed Description.

A non-transitory computer readable medium as substantially described herein with reference to each or any combination substantially described herein, comprised in examples 1-35, and in the Detailed Description.

A wireless device configured to perform any action or combination of actions as substantially described herein, comprised in examples 1-35, and in the Detailed Description.

An integrated circuit configured to perform any action or combination of actions as substantially described herein, comprised in examples 1-35, and in the Detailed Description.

An apparatus configured to perform any action or combination of actions as substantially described herein, comprised in examples 1-35, and in the Detailed Description.

A baseband processor configured to perform any action or combination of actions as substantially described herein, comprised in examples 1-35, and in the Detailed Description.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communication media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal or apparatus.

In this regard, while the disclosed subject matter has been described in connection with various aspects and corresponding Figures, where applicable, it is to be understood that other similar aspects can be used or modifications and additions can be made to the described aspects for performing the same, similar, alternative, or substitute function of the disclosed subject matter without deviating therefrom. Therefore, the disclosed subject matter should not be limited to any single aspect described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

The present disclosure is described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable or non-transitory computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor, comprising:
one or more processors configured to:
receive a region indication for clear channel assessment (CCA) procedures associated with a listen before talk (LBT) region configuration for one of a first region, a second region, or a third region;
receive a downlink control information (DCI) comprising a DCI CCA indication;
perform an initial LBT procedure associated with the region indication;
generate, for transmission, a random access channel (RACH) message after performing the initial LBT procedure; and
generate, for transmission, an uplink (UL) message according to the DCI CCA indication.

2. The baseband processor of claim 1, wherein LBT operations are not mandated in the first region, LBT operations are associated with at least some regulation in the second region, and wherein LBT is mandatory in the third region.

3. (canceled)

4. The baseband processor of claim 1, wherein the region indication is comprised in a channelAccessMode-r17 resource which is comprised in a ServingCellConfigCommon resource or ServingCellConfigCommonSIB resource.

5. The baseband processor of claim 1, wherein the region indication is received in a radio resource control (RRC) message.

6. The baseband processor of claim 1, wherein the processors are further configured to establish a RRC connection after receiving the DCI CCA indication.

7. The baseband processor of claim 1, wherein the region indication indicates the first region or the second region and the initial LBT procedure is a no LBT procedure, and the processors are configured to:
generate the RACH message without performing a LBT procedure before generating the RACH message.

8.-36. (canceled)

37. A user equipment (UE), comprising:
a memory circuit;
a radio frequency (RF) module; and
one or more processors configure to, when executing instructions stored in the memory circuit, cause the UE to:
receive a region indication for clear channel assessment (CCA) procedures associated with a listen before talk (LBT) region configuration for one of a first region, a second region, or a third region;
receive a downlink control information (DCI) comprising a DCI CCA indication;
perform an initial LBT procedure associated with the region indication;
transmit, by the RF module, a random access channel (RACH) message after performing the initial LBT procedure; and
transmit, by the RF module, an uplink (UL) message according to the DCI CCA indication.

38. The UE of claim 37, wherein the region indication indicates the third region and the initial LBT procedure is one or more of a category 2 (CAT2) procedure or CAT3 procedure, and the one or more processors are configured to:
perform one or more of the CAT2 procedure or CAT3 procedure; and
transmit, by the RF module, a RACH message after performing one or more of the CAT2 procedure or CAT3 procedure.

39. The UE of claim 37, wherein the region indication indicates the first region or the second region and the DCI CCA indication indicates a no LBT procedure and the one or more processors are configured to:
transmit, by the RF module, the UL message without performing a LBT procedure in response to the DCI CCA indication.

40. The UE of claim 37, wherein the region indication indicates the first region or the second region and wherein the one or more processors are further configured to:
receive a random access response (RAR) message with a CCA indication wherein the CCA indication is 0, 1, or 2 bits;
perform a LBT procedure according to the CCA indication; and
transmit, by the RF module, the UL message in response performing the LBT procedure.

41. The UE of claim 37, wherein the region indication indicates the second region and the DCI CCA indication indicates a CAT3 procedure and the one or more processors are configured to:
perform the CAT3 procedure; and
transmit, by the RF module, the UL message after performing the CAT3 procedure.

42. The UE of claim 37, wherein the region indication indicates the third region and the DCI CCA indication indicates one or more of a CAT2 procedure or a CAT3 procedure and the one or more processors are configured to:
perform one or more of the CAT2 procedure or the CAT3 procedure; and
transmit, by the RF module, the UL message after performing one or more of the CAT2 procedure or the CAT3 procedure.

43. The UE of claim 42, wherein the DCI CCA indication is the received DCI without any dedicated CCA bits.

44. A method for a user equipment (UE), the method comprising:
receiving a region indication for clear channel assessment (CCA) procedures associated with a listen before talk (LBT) region configuration for one of a first region, a second region, or a third region;
receive a downlink control information (DCI) comprising a DCI CCA indication;
perform an initial LBT procedure associated with the region indication;
transmit a random access channel (RACH) message after performing the initial LBT procedure; and
transmit an uplink (UL) message according to the DCI CCA indication.

45. The method of claim 44, wherein the region indication indicates the first region and the DCI CCA indication is a one bit CCA indicator that indicates a no LBT procedure and wherein the method further includes:
transmitting the UL message without performing a LBT operation.

46. The method of claim 44, wherein the region indication indicates the second region and the DCI CCA indication is a one bit CCA indicator that indicates a CAT3 procedure or a no LBT procedure and the method further includes:
performing the CAT3 procedure or perform no LBT procedure according to the one bit CCA indicator; and
transmitting the UL message after performing the CAT3 procedure or performing no LBT procedure.

47. The method of claim 44, wherein the region indication indicates the third region and the DCI CCA indication is a one bit CCA indicator that indicates a CAT2 procedure or a CAT3 procedure and the one or more processors are configured to:
perform the CAT2 procedure or the CAT3 procedure; and
transmit the UL message after performing the CAT2 procedure or the CAT3 procedure.

48. The method of claim 44, wherein the DCI CCA indication is a two bit CCA indicator comprised in a DCI format 0_0 or a DCI format 1_0 and indicates a category 1 (CAT1) procedure, CAT2 procedure, or a CAT3 procedure and the one or more processors are configured to:
perform one of the CAT1, CAT2, or CAT3 procedure; and
transmit the UL message after performing one of the CAT1, CAT2, or CAT3 procedure.

49. The method of claim 48, wherein one of the CAT1, CAT2, or CAT3 procedure is performed after establishing a cell specific or a UE specific RRC connection.

50. The method of claim 44, wherein the region indication indicates the first region or the second region and the initial LBT procedure is a no LBT procedure, and the method further includes:
transmitting the RACH message without performing a LBT procedure before transmitting the RACH message.
